(19) United States
(12) Patent Application Publication
(10) Pub. No.: US 2026/0160668 A1
(43) Pub. Date: Jun. 11, 2026

(54) IN-SITU TEST DEVICE AND METHOD FOR FRICTION CHARACTERISTIC OF INTERFACE OF VALVE PLATE PAIR IN CAM-LOBE RADIAL PISTON HYDRAULIC MOTOR

(71) Applicant: Zhejiang University, Hangzhou (CN)

(72) Inventors: Chao ZHANG, Hangzhou (CN); Yiman DUAN, Hangzhou (CN); Yu FANG, Hangzhou (CN); Xiaolong ZHANG, Hangzhou (CN); Jianxiong WU, Hangzhou (CN); Danghui WANG, Hangzhou (CN); Yiming YUE, Hangzhou (CN); Weidi HUANG, Hangzhou (CN); Junhui ZHANG, Hangzhou (CN); Bing XU, Hangzhou (CN)

(73) Assignee: Zhejiang University, Hangzhou (CN)

(21) Appl. No.: 19/407,021

(22) Filed: Dec. 3, 2025

(30) Foreign Application Priority Data
Dec. 6, 2024 (CN) 202411785558.5

(51) Int. Cl. G01N 19/02; G01M 13/003

(52) U.S. Cl. CPC G01N 19/02; G01M 13/003

(57) ABSTRACT

The provided is an in-situ test device and method for a friction characteristic of an interface of a valve plate pair in a cam-lobe radial piston hydraulic motor. A transmission shaft of a valve plate pair realistic-simulation module is connected to a motor; and the valve plate pair realistic-simulation module is threadedly connected to a valve plate pair guide module. By controlling a rotational speed of the motor and pressures of high-pressure and low-pressure port windows of a valve plate, the provided can realistically reproduce high-pressure and low-pressure port distribution functions of the valve plate pair in the hydraulic motor and simulate a wear state of the interface between the valve plate and the cylinder block, such that the friction characteristic of the interface of the valve plate pair is the same as an in-situ test result.

### CROSS-REFERENCE TO THE RELATED APPLICATIONS

This application is based upon and claims priority to Chinese Patent Application No. 202411785558.5, filed on Dec. 6, 2024, the entire contents of which are incorporated herein by reference.

### TECHNICAL FIELD

The present disclosure belongs to the technical field of cam-lobe radial piston hydraulic motors, and in particular to an in-situ test device and method for a friction characteristic of an interface of a valve plate pair in a cam-lobe radial piston hydraulic motor.

### BACKGROUND

At present, super-high-torque and low-speed hydraulic drive systems have been applied to various national key equipment, such as screw conveyor systems of large shield machines, cutter drive systems of dredgers, and other large-scale rotary drive systems. Compared with drive methods such as high-speed hydraulic motors/electric motors and reducers, cam-lobe radial piston hydraulic motors have advantages of high power density, light weight and compact size.

However, numerous interfaces of friction pairs in the compact space of the cam-lobe radial piston hydraulic motors exhibit strong nonlinearities and fluctuations in friction behavior, which restricts the mechanical efficiency and volumetric efficiency of the cam-lobe radial piston hydraulic motors. The valve plate pair is one of key friction pairs in the cam-lobe radial piston hydraulic motors, and its structure and functional characteristics are crucial for efficiency of the motors. Existing research on friction characteristics of the valve plate pair in the cam-lobe radial piston hydraulic motors is mainly conducted through overall tests. Because of the numerous interfaces of the friction pairs in the cam-lobe radial piston hydraulic motors, it is difficult to qualitatively identify and quantitatively isolate which specific friction pair contributes to the friction or even to temperature rise of the motors, and comprehensive characteristics of a single friction pair cannot be studied. Furthermore, moving assemblies need to be replaced frequently since components such as rollers and pistons in the motors are more susceptible to damage during the overall tests, leading to high test costs and long test cycles. This limits the design optimization and performance improvement of the valve plate pair in the cam-lobe radial piston hydraulic motors.

Therefore, in order to study friction and wear characteristics of the valve plate pair and improve efficiency of the cam-lobe radial piston hydraulic motor, the present disclosure provides an in-situ test device and method for a friction characteristic of an interface of a valve plate pair in a cam-lobe radial piston hydraulic motor. The present disclosure improves the performance of the cam-lobe radial piston hydraulic motor to meet requirements in different application fields.

### SUMMARY

In view of deficiencies of the prior art, an objective of the present disclosure is to provide an in-situ test device and method for a friction characteristic of an interface of a valve plate pair in a cam-lobe radial piston hydraulic motor.

The above objective of the present disclosure is achieved with the following technical solutions: An in-situ test device for a friction characteristic of an interface of a valve plate pair in a cam-lobe radial piston hydraulic motor includes a motor, a valve plate pair realistic-simulation module, and a valve plate pair guide module, where

the valve plate pair realistic-simulation module includes a transmission shaft, a cylinder block, a loading chamber, a valve plate, as well as a high-pressure port window and a low-pressure port window of the valve plate; the cylinder block in the valve plate pair realistic-simulation module is connected to the motor through the transmission shaft; the high-pressure port window and the low-pressure port window of the valve plate are arranged in a staggered manner; and the loading chamber is configured to input oil, such that a loading force of chamber oil is the same as a pressing force of the valve plate to realize calibration of a friction torque in an equivalent in-situ test;

the valve plate pair guide module includes an oil inlet circuit and an oil return circuit; the oil inlet circuit of the valve plate pair guide module communicates with the high-pressure port window of the valve plate; and the oil return circuit of the valve plate pair guide module communicates with the low-pressure port window of the valve plate; and

a torque sensor is disposed on the transmission shaft; and the torque sensor is configured to obtain a friction torque of an interface of a valve plate pair through data acquisition, calibration, and calculation.

Further, the valve plate pair realistic-simulation module is provided with a self-aligning ball bearing configured to ensure that the valve plate pair realistic-simulation module and the valve plate pair guide module are always concentric with the transmission shaft.

Further, the valve plate pair realistic-simulation module is provided with a thrust cylindrical roller bearing configured to bear an axial force applied to the cylinder block.

Further, the valve plate pair realistic-simulation module is provided with a port distribution state observation window configured to observe a flow state of a flow field of the valve plate pair.

Further, when a cylinder block window of the cylinder block in the valve plate pair realistic-simulation module communicates with the high-pressure port window of the valve plate, high-pressure oil enters an oil port through the oil inlet circuit of the valve plate pair guide module, and then enters the interface of the valve plate pair through the high-pressure port window of the valve plate; and the high-pressure oil is input to the cylinder block window of the cylinder block in the valve plate pair realistic-simulation module and enters a piston chamber of the cylinder block, completing a high-pressure oil inflow function of the valve plate.

Further, when the cylinder block window of the cylinder block in the valve plate pair realistic-simulation module communicates with the low-pressure port window of the valve plate, the high-pressure oil in the piston chamber of the cylinder block becomes low-pressure oil, and the low-pressure oil flows from the cylinder block window of the cylinder block in the valve plate pair realistic-simulation module to the low-pressure port window of the valve plate, enters the oil port of the valve plate pair guide module, and returns to an oil tank through the oil return circuit, completing a low-pressure oil outflow function of the valve plate.

Further, the loading chamber of the valve plate pair realistic-simulation module is configured to control an oil input pressure, such that a loading pressure of the loading chamber generates the loading force for the transmission shaft; and the loading force is the same as the pressing force of the valve plate.

Further, a friction torque between the transmission shaft and a transmission system connected to the transmission shaft is measured by the torque sensor when the valve plate does not work, and a friction torque measured by the torque sensor is calibrated when the valve plate works, thereby eliminating an influence of the friction torque between the transmission shaft and the transmission system connected to the transmission shaft on the friction torque of the valve plate pair, and realizing calibration of the friction torque in the equivalent in-situ test.

Further, a valve plate pair realistic-simulation module chamber oil inlet is configured to input the oil and fill the valve plate pair realistic-simulation module with the oil, so as to simulate an in-situ working environment of the valve plate pair in a hydraulic motor.

In another aspect, the present disclosure further provides an in-situ test method for a friction characteristic of an interface of a valve plate pair in a cam-lobe radial piston hydraulic motor, including following steps:
(1) according to an assembly sequence of the valve plate pair realistic-simulation module, respectively disposing a tested valve plate and a corresponding cylinder block at corresponding positions of the valve plate pair realistic-simulation module, and adjusting an initial fit clearance between the tested valve plate and the corresponding cylinder block;
(2) upon completion of assembly of the valve plate pair realistic-simulation module, connecting the transmission shaft to the torque sensor through the coupling, and fixedly connecting the valve plate pair realistic-simulation module to a test bench through a bolt;
(3) respectively connecting the valve plate pair realistic-simulation module chamber oil inlet, a valve plate pair high-pressure oil inlet, a valve plate pair realistic-simulation module chamber oil return port, a valve plate pair loading circuit oil port, and a valve plate pair low-pressure oil return port to corresponding oil ports of a hydraulic system, and respectively disposing a valve plate pair leakage port pressure-temperature sensor, a valve plate pair high-pressure port pressure-temperature sensor, a valve plate pair loading circuit pressure-temperature sensor, and a valve plate pair low-pressure port pressure-temperature sensor at corresponding positions;
(4) starting the hydraulic system, filling a chamber of the valve plate pair realistic-simulation module with the oil through the valve plate pair realistic-simulation module chamber oil inlet, closing the valve plate pair realistic-simulation module chamber oil inlet after the chamber of the valve plate pair realistic-simulation module is filled with the oil, opening the valve plate pair realistic-simulation module chamber oil return port, and adjusting a working pressure and an oil temperature of the tested valve plate;
(5) starting the motor, and adjusting a rotational speed of the motor to change a working rotational speed for controlling the cylinder block;
(6) adjusting the working pressure and the working rotational speed through a test process from the steps (1) to (5) to test friction characteristics of the valve plate pair in different working conditions of the tested valve plate;
(7) upon completion of testing in the different working conditions, switching the hydraulic system, closing the valve plate pair high-pressure oil inlet such that the tested valve plate is in a non-port distribution working state, opening the valve plate pair loading circuit oil port, adjusting an oil pressure of a loading circuit according to a pressing force of the tested valve plate such that the oil pressure is consistent with a residual pressing force of the tested valve plate, measuring a friction torque between the transmission shaft and the transmission system connected to the transmission shaft, and subtracting the friction torque from a friction torque tested in the step (6) to obtain a friction torque of the valve plate pair; and
(8) upon completion of the above testing, removing the tested valve plate, and observing a wear state of the valve plate pair through a microscope.

The present disclosure has following beneficial effects:
1. With the valve plate pair guide module and the valve plate pair realistic-simulation module, the in-situ test device and method for a friction characteristic of an interface of a valve plate pair in a cam-lobe radial piston hydraulic motor provided by the present disclosure can realistically reproduce the high-pressure and low-pressure port distribution functions of the valve plate pair in the hydraulic motor and simulate the wear state of the interface between the valve plate and the cylinder block, such that the friction characteristic of the interface of the valve plate pair is the same as an in-situ test result.
2. Compared with the cam-lobe radial piston hydraulic motor, the test device for a friction characteristic of an interface of a valve plate pair in a cam-lobe radial piston hydraulic motor provided by the present disclosure has fewer components and high reliability. Particularly, when friction characteristics of different interfaces of the valve plate pair in durable working conditions are studied, the test device provided by the present disclosure only needs to replace different valve plates. However, in the overall test on the hydraulic motor, not only are the different valve plates replaced, but the components such as the internal rollers and the internal pistons are more susceptible to damage and need to be replaced frequently, causing high test costs and long assembly cycles.
3. Since the valve plate pair realistic-simulation module is replaceable and can be assembled and disassembled conveniently, the test device for a friction characteristic of an interface of a valve plate pair in a cam-lobe radial piston hydraulic motor provided by the present disclosure can realize comprehensive performance testing on various types of valve plate pairs by replacing the valve plate pair realistic-simulation module, and has versatility and universality for the comprehensive performance testing on the valve plate of the cam-lobe radial piston hydraulic motor.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and those skilled in the art may still derive other drawings from these accompanying drawings without creative efforts.

FIG. 1 is an axonometric view of an in-situ test device for a friction characteristic of an interface of a valve plate pair in a cam-lobe radial piston hydraulic motor according to the present disclosure;

FIG. 2 is a left view of an in-situ test device for a friction characteristic of an interface of a valve plate pair in a cam-lobe radial piston hydraulic motor according to the present disclosure;

FIG. 3 is a sectional (A-A) view of a valve plate pair realistic-simulation module, a valve plate pair guide module, and a sealing end cover of an in-situ test device for a friction characteristic of an interface of a valve plate pair in a cam-lobe radial piston hydraulic motor according to the present disclosure;

FIG. 4 is a sectional (B-B) view of a valve plate pair realistic-simulation module, a valve plate pair guide module, and a sealing end cover of an in-situ test device for a friction characteristic of an interface of a valve plate pair in a cam-lobe radial piston hydraulic motor according to the present disclosure;

FIG. 5 is a schematic diagram of a valve plate in a valve plate pair realistic-simulation module of an in-situ test device for a friction characteristic of an interface of a valve plate pair in a cam-lobe radial piston hydraulic motor according to the present disclosure;

FIG. 6 illustrates a cylinder block in a valve plate pair realistic-simulation module of an in-situ test device for a friction characteristic of an interface of a valve plate pair in a cam-lobe radial piston hydraulic motor and a sectional view thereof according to the present disclosure;

FIG. 7 is a schematic diagram of a valve plate pair guide module of an in-situ test device for a friction characteristic of an interface of a valve plate pair in a cam-lobe radial piston hydraulic motor according to the present disclosure;

FIG. 8 is a schematic diagram of a wear condition after valve plate 6.1a of an in-situ test device for a friction characteristic of an interface of a valve plate pair in a cam-lobe radial piston hydraulic motor is tested by the in-situ test device according to the present disclosure; and

FIG. 9 is a schematic diagram of a wear condition after valve plate 6.1b of an in-situ test device for a friction characteristic of an interface of a valve plate pair in a cam-lobe radial piston hydraulic motor is disposed on a hydraulic motor and tested on a comprehensive performance test bench according to the present disclosure.

Reference numerals in the figures: 1—motor, 2—reducer, 3—reducer bracket, 4—coupling, 5—torque sensor, 6—valve plate pair realistic-simulation module, 7—port distribution state observation window, 8—valve plate pair guide module, 9—sealing end cover, 10—valve plate pair leakage port pressure-temperature sensor, 11—valve plate pair high-pressure port pressure-temperature sensor, 12—valve plate pair loading circuit pressure-temperature sensor, 13—test bench, 14—eddy-current displacement sensor, 15—valve plate pair realistic-simulation module chamber oil inlet, 16—first connecting bolt for the valve plate pair realistic-simulation module and the sealing end cover, 17—valve plate pair high-pressure oil inlet, 18—second connecting bolt for the valve plate pair realistic-simulation module and the sealing end cover, 19—valve plate pair realistic-simulation module chamber oil return port, 20—valve plate pair loading circuit oil port, 21—valve plate pair low-pressure oil return port, 22—connecting bolt for the valve plate pair guide module and the valve plate pair realistic-simulation module, 23—valve plate pair low-pressure port pressure-temperature sensor, 6.1—valve plate of the valve plate pair realistic-simulation module, 6.2—second self-aligning ball bearing of the valve plate pair realistic-simulation module, 6.3—cylinder block of the valve plate pair realistic-simulation module, 6.4—left end cover of the valve plate pair realistic-simulation module, 6.5—bottom end cover of the valve plate pair realistic-simulation module, 6.6—thrust cylindrical roller bearing of the valve plate pair realistic-simulation module, 6.7—first self-aligning ball bearing of the valve plate pair realistic-simulation module, 6.8—transmission shaft of the valve plate pair realistic-simulation module, 6.9—support end cover of the valve plate pair realistic-simulation module, 6.10—right end cover of the valve plate pair realistic-simulation module, 6.11—top end cover of the valve plate pair realistic-simulation module, 6.12—connecting bolt for the valve plate pair realistic-simulation module and the port distribution state observation window, 6.13—loading chamber of the valve plate pair realistic-simulation module, 6.14—connecting bolt for the cylinder block and the transmission shaft of the valve plate pair realistic-simulation module, 6.1.1—limit bolt mounting hole of the valve plate, 6.1.2—high-pressure port window of the valve plate, 6.1.3—low-pressure port window of the valve plate, 6.1.4—eddy-current sensor mounting hole of the valve plate, 6.1.5—transition window of the valve plate, 6.1.6—spring sliding sleeve of the valve plate, 6.1.7—spring of the valve plate, 6.1.8—balance piston of the valve plate, 6.3.1—sealing window cover of the cylinder block, 6.3.2—cylinder block window of the cylinder block, 6.3.3—locating pin of the cylinder block, 6.3.4—piston chamber of the cylinder block, 6.3.5—first connecting surface of the cylinder block, 6.3.6—second connecting surface of the cylinder block, 8.1—connecting threaded hole between the valve plate pair guide module and the valve plate pair realistic-simulation module, 8.2—oil port of the valve plate pair guide module, 8.3—eddy-current sensor wire hole of the valve plate pair guide module, 8.4—connecting threaded hole between the valve plate pair guide module and the valve plate, 8.5—oil inlet circuit of the valve plate pair guide module, 8.6—first sealing ring of the valve plate pair guide module, 8.7—second sealing ring of the valve plate pair guide module, 8.8—third sealing ring of the valve plate pair guide module, 8.9—annular sealing Glyd ring mounting surface of the valve plate pair guide module, 8.10—self-aligning ball bearing mounting surface of the valve plate pair guide module, 8.11—oil return circuit of the valve plate pair guide module, and 8.12—fourth sealing ring of the valve plate pair guide module.

### DETAILED DESCRIPTION OF THE EMBODIMENTS

The preferred embodiments of the present disclosure will be described in detail below with reference to the accompanying drawings, so that the advantages and features of the present disclosure can be more easily understood by those skilled in the art, and thus the protection scope of the present disclosure can be defined more clearly.

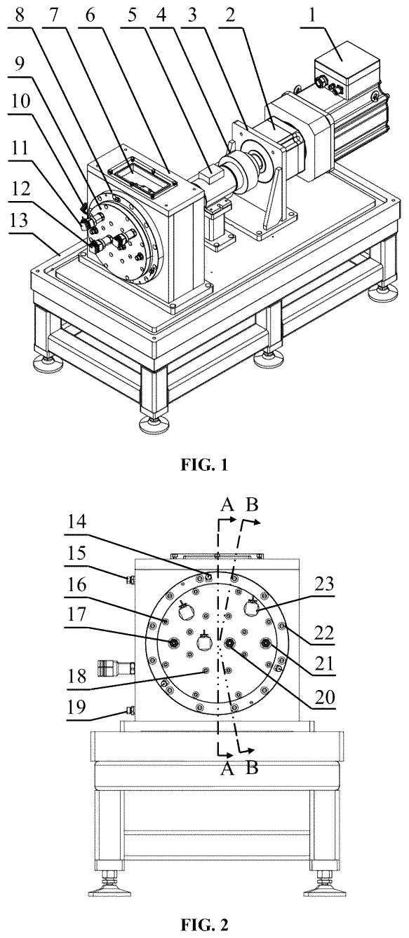

The present disclosure is further described below with reference to the accompanying drawings. The present disclosure provides an in-situ test device for a friction characteristic of an interface of a valve plate pair in a cam-lobe radial piston hydraulic motor. As shown in FIG. 1 and FIG. 2, the in-situ test device for a friction characteristic of an interface of a valve plate pair in a cam-lobe radial piston hydraulic motor includes motor 1, reducer 2, reducer bracket 3, coupling 4, torque sensor 5, valve plate pair realistic-simulation module 6, port distribution state observation window 7, valve plate pair guide module 8, sealing end cover 9, valve plate pair leakage port pressure-temperature sensor 10, valve plate pair high-pressure port pressure-temperature sensor 11, valve plate pair loading circuit pressure-temperature sensor 12, test bench 13, eddy-current displacement sensor 14, valve plate pair realistic-simulation module chamber oil inlet 15, first connecting bolt 16 for the valve plate pair realistic-simulation module and the sealing end cover, valve plate pair high-pressure oil inlet 17, second connecting bolt 18 for the valve plate pair realistic-simulation module and the sealing end cover, valve plate pair realistic-simulation module chamber oil return port 19, valve plate pair loading circuit oil port 20, valve plate pair low-pressure oil return port 21, connecting bolt 22 for the valve plate pair guide module and the valve plate pair realistic-simulation module, and valve plate pair low-pressure port pressure-temperature sensor 23.

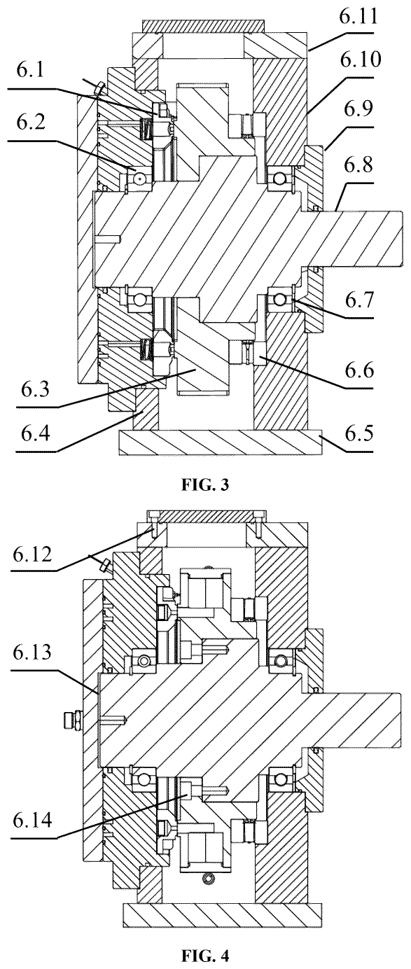

FIG. 3 and FIG. 4 illustrate the valve plate pair realistic-simulation module, the valve plate pair guide module, and the sealing end cover in the in-situ test device for a friction characteristic of an interface of a valve plate pair in a cam-lobe radial piston hydraulic motor provided by the present disclosure. The valve plate pair realistic-simulation module includes valve plate 6.1 of the valve plate pair realistic-simulation module, second self-aligning ball bearing 6.2 of the valve plate pair realistic-simulation module, cylinder block 6.3 of the valve plate pair realistic-simulation module, left end cover 6.4 of the valve plate pair realistic-simulation module, bottom end cover 6.5 of the valve plate pair realistic-simulation module, thrust cylindrical roller bearing 6.6 of the valve plate pair realistic-simulation module, first self-aligning ball bearing 6.7 of the valve plate pair realistic-simulation module, transmission shaft 6.8 of the valve plate pair realistic-simulation module, support end cover 6.9 of the valve plate pair realistic-simulation module, right end cover 6.10 of the valve plate pair realistic-simulation module, top end cover 6.11 of the valve plate pair realistic-simulation module, connecting bolt 6.12 for the valve plate pair realistic-simulation module and the port distribution state observation window, loading chamber 6.13 of the valve plate pair realistic-simulation module, and connecting bolt 6.14 for the cylinder block and the transmission shaft of the valve plate pair realistic-simulation module.

As shown in FIGS. 1-4, the valve plate pair realistic-simulation module 6 is fixed on the test bench 13. The valve plate pair realistic-simulation module 6 is threadedly connected to the valve plate pair guide module 8 through connecting threaded hole 8.1. The cylinder block 6.3 and the transmission shaft 6.8 in the valve plate pair realistic-simulation module are in interference fit through the connecting bolt 6.14. The transmission shaft 6.8 is connected to the torque sensor 5 through the coupling 4. Another side of the torque sensor 5 is connected to the reducer 2 through the coupling 4. The reducer 2 is fixed on the reducer bracket 3, with another side connected to the motor 1, and coaxially connected to the motor 1 to drive the cylinder block 6.3 in the valve plate pair realistic-simulation module to rotate. A rotational speed of the cylinder block 6.3 is indirectly controlled by controlling a rotational speed of the motor 1. The torque sensor 5 is configured to obtain, through data acquisition, shafting calibration, and calculation, a friction torque of a valve plate pair consisting of the valve plate 6.1 and the cylinder block 6.3 in the valve plate pair realistic-simulation module.

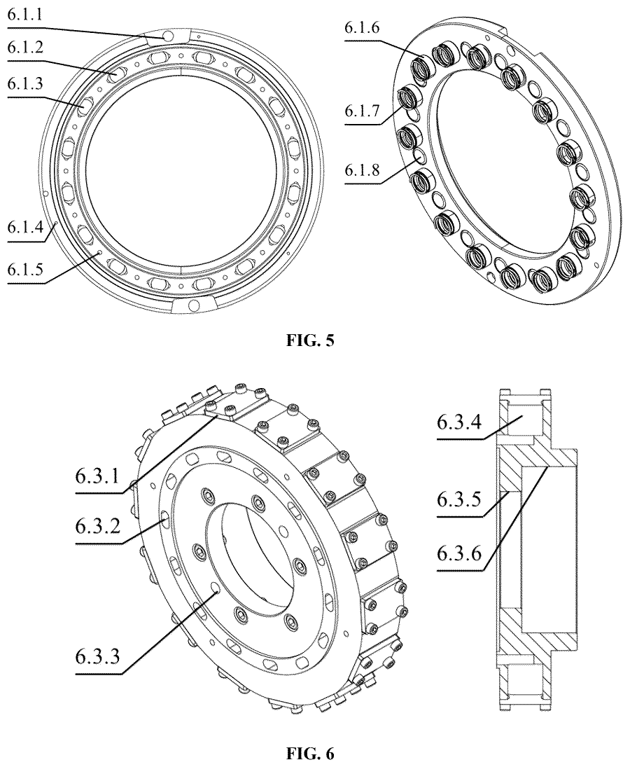

FIG. 5 illustrates the valve plate in the in-situ test device for a friction characteristic of an interface of a valve plate pair in a cam-lobe radial piston hydraulic motor provided by the present disclosure, including limit bolt mounting hole 6.1.1 of the valve plate, high-pressure port window 6.1.2 of the valve plate, low-pressure port window 6.1.3 of the valve plate, eddy-current sensor mounting hole 6.1.4 of the valve plate, transition window 6.1.5 of the valve plate, spring sliding sleeves 6.1.6 of the valve plate, spring 6.1.7 of the valve plate, and balance piston 6.1.8 of the valve plate. The valve plate pair guide module 8 and the valve plate 6.1 of the valve plate pair realistic-simulation module are connected through a bolt in the limit bolt mounting hole 6.1.1 and connecting threaded hole 8.4 between the valve plate pair guide module and the valve plate. The high-pressure port window 6.1.2 of the valve plate, the transition window 6.1.5 of the valve plate, and the low-pressure port window 6.1.3 of the valve plate are sequentially arranged in a staggered manner. The spring sliding sleeves 6.1.6 at an inlet side and an outlet side of the valve plate 6.1 in the valve plate pair realistic-simulation module are concentric with each port window. The spring 6.1.7 is placed into the spring sliding sleeve 6.1.6. The spring sliding sleeve 6.1.6 is completely tightly attached to the inlet side of the valve plate by means of an oil pressure and a spring pressure. The eddy-current displacement sensor 14 is disposed through eddy-current sensor wire hole 8.3 of the valve plate pair guide module and the eddy-current sensor mounting hole 6.1.4 of the valve plate, with a sensor testing end parallel to a port distribution surface, keeping a certain initial gap with a cylinder block mating surface, and configured to test a thickness of an oil film of the valve plate pair.

FIG. 6 illustrates the cylinder block in the in-situ test device for a friction characteristic of an interface of a valve plate pair in a cam-lobe radial piston hydraulic motor provided by the present disclosure, including sealing window cover 6.3.1 of the cylinder block, cylinder block window 6.3.2 of the cylinder block, locating pin 6.3.3 of the cylinder block, piston chamber 6.3.4 of the cylinder block, first connecting surface 6.3.5 of the cylinder block, and second connecting surface 6.3.6 of the cylinder block. The cylinder block 6.3 is connected to the transmission shaft 6.8 through the locating pin 6.3.3 of the cylinder block for limiting. The first connecting surface 6.3.5 of the cylinder block and the second connecting surface 6.3.6 of the cylinder block are in interference fit with the transmission shaft 6.8. The sealing window cover 6.3.1 of the cylinder block is connected to the piston chamber 6.3.4 through a bolt.

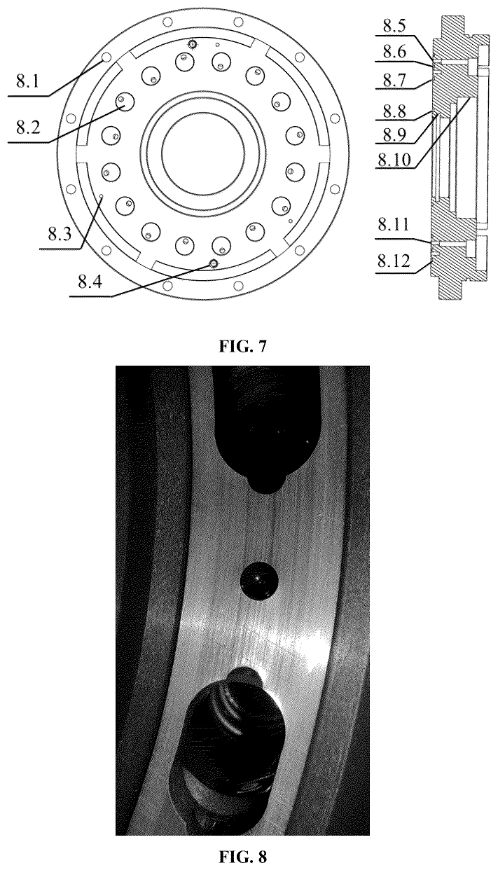

FIG. 7 illustrates the valve plate pair guide module in the in-situ test device for a friction characteristic of an interface of a valve plate pair in a cam-lobe radial piston hydraulic motor provided by the present disclosure, including the connecting threaded hole 8.1 between the valve plate pair guide module and the valve plate pair realistic-simulation module, oil port 8.2 of the valve plate pair guide module, the eddy-current sensor wire hole 8.3 of the valve plate pair guide module, the connecting threaded hole 8.4 between the valve plate pair guide module and the valve plate, oil inlet circuit 8.5 of the valve plate pair guide module, first sealing ring 8.6 of the valve plate pair guide module, second sealing ring 8.7 of the valve plate pair guide module, third sealing ring 8.8 of the valve plate pair guide module, annular sealing Glyd ring mounting surface 8.9 of the valve plate pair guide module, self-aligning ball bearing mounting surface 8.10 of the valve plate pair guide module, oil return circuit 8.11 of the valve plate pair guide module, and fourth sealing ring 8.12 of the valve plate pair guide module. The oil port 8.2 of the valve plate pair guide module is concentric and clearance-fitted with the spring sliding sleeves 6.1.6 at the inlet side and the outlet side of the valve plate 6.1 in the valve plate pair realistic-simulation module. The oil inlet circuit 8.5 of the valve plate pair guide module communicates with the valve plate pair high-pressure oil inlet 17, so as to flow high-pressure oil to the valve plate 6.1. The oil return circuit 8.11 of the valve plate pair guide module communicates with the valve plate pair low-pressure oil return port 21, so as to flow out low-pressure oil of the valve plate 6.1. The first sealing ring 8.6 of the valve plate pair guide module, the second sealing ring 8.7 of the valve plate pair guide module, the third sealing ring 8.8 of the valve plate pair guide module, and the fourth sealing ring 8.12 of the valve plate pair guide module are configured to isolate oil in different chambers to prevent oil leakage. The annular sealing Glyd ring mounting surface 8.9 of the valve plate pair guide module is provided with a Glyd ring to prevent leakage of high-pressure oil in the loading chamber 6.13 of the valve plate pair realistic-simulation module. The self-aligning ball bearing mounting surface 8.10 of the valve plate pair guide module is provided with the second self-aligning ball bearing 6.2 of the valve plate pair realistic-simulation module to ensure that the valve plate pair guide module 8 is always concentric with the transmission shaft 6.8.

As shown in FIGS. 3-7, when the cylinder block window 6.3.2 of the valve plate pair realistic-simulation module communicates with the high-pressure port window 6.1.2 of the valve plate, high-pressure oil enters the oil port 8.2 through the oil inlet circuit 8.5 of the valve plate pair guide module, and then enters the interface of the valve plate pair through the high-pressure port window 6.1.2 of the valve plate. The high-pressure oil is input to the cylinder block window 6.3.2 of the cylinder block 6.3 of the valve plate pair realistic-simulation module and enters the piston chamber 6.3.4 of the cylinder block, completing a high-pressure oil inflow function of the valve plate 6.1.

As shown in FIGS. 3-7, when the cylinder block window 6.3.2 of the valve plate pair realistic-simulation module communicates with the low-pressure port window 6.1.3 of the valve plate, the high-pressure oil in the piston chamber 6.3.4 of the cylinder block becomes low-pressure oil, and the low-pressure oil flows from the cylinder block window 6.3.2 of the cylinder block 6.3 of the valve plate pair realistic-simulation module to the low-pressure port window 6.1.3 of the valve plate, enters the oil port 8.2 of the valve plate pair guide module, and returns to an oil tank through the oil return circuit 8.11, completing a low-pressure oil outflow function of the valve plate 6.1.

As shown in FIGS. 1-4, the valve plate pair loading circuit oil port 20 communicates with the loading chamber 6.13 of the valve plate pair realistic-simulation module, so as to control an oil input pressure to ensure that a loading pressure in the loading chamber is the same as a pressing force of the valve plate, calibrate a friction torque of a transmission system of a mechanical structure in a non-port distribution working condition, and compare the friction torque with a friction torque of a whole system when the valve plate works, thereby accurately obtaining a friction torque of a valve plate pair.

As shown in FIGS. 1-4, the port distribution state observation window 7 is made of a transparent material, and may be configured to directly observe a flow state of a flow field of the valve plate pair. The valve plate 6.1 and the cylinder block 6.3 may further be made of a transparent material such as an acrylic plate. A particle image velocimetry (PIV) observation device is used to test streamline distribution, vortices and other states of an oil flow field of the valve plate in a low-pressure working condition.

As shown in FIG. 1 and FIG. 2, the valve plate pair leakage port pressure-temperature sensor 10, the valve plate pair high-pressure port pressure-temperature sensor 11, and the valve plate pair low-pressure port pressure-temperature sensor 23 may be respectively configured to test oil pressures and oil temperatures of a high-pressure port, a low-pressure port, and a leakage port of the valve plate pair.

As shown in FIG. 2, the valve plate pair realistic-simulation module chamber oil inlet 15 is configured to input oil with a certain pressure and fill the valve plate pair realistic-simulation module 6 with the oil, so as to simulate an oil-immersed working state of the valve plate pair in a hydraulic motor. After the chamber of the valve plate pair realistic-simulation module is filled with the oil, the valve plate pair realistic-simulation module chamber oil inlet 15 is closed, and the valve plate pair realistic-simulation module chamber oil return port 19 is opened. Due to a backpressure, the oil in the chamber of the valve plate pair realistic-simulation module does not flow out. When the valve plate starts to work, leaked oil generated by the valve plate pair flows to the chamber of the valve plate pair realistic-simulation module. In this case, a total amount of oil in the sealed chamber is increased. Due to incompressibility of the oil, an oil pressure in the chamber is increased, and excess oil flows out from the valve plate pair realistic-simulation module chamber oil return port 19. Until the total amount of oil is recovered to a volume when the chamber is just fully filled, the oil in the chamber of the valve plate pair realistic-simulation module ceases to flow out.

As shown in FIG. 3 and FIG. 4, the eddy-current displacement sensor 14 may be configured to verify an initial fit clearance between the valve plate 6.1 and the cylinder block 6.3, ensuring that their mounting states are the same as their mounting positions in the hydraulic motor. Through the oil pressures and the oil temperatures of the high-pressure port, the low-pressure port, and the leakage port, a stressed state of the valve plate pair is the same as a stressed state of the valve plate pair of the hydraulic motor, thereby obtaining a frictional wear state of the valve plate.

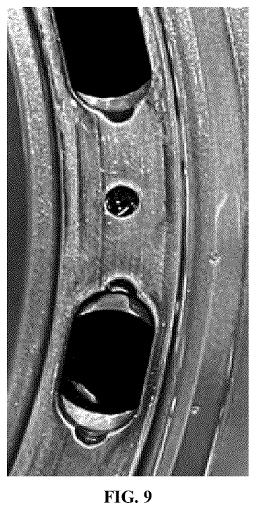

Corresponding to the embodiment of the in-situ test device for a friction characteristic of an interface of a valve plate pair in a cam-lobe radial piston hydraulic motor, the present disclosure further provides a test method of the in-situ test device for a friction characteristic of an interface of a valve plate pair in a cam-lobe radial piston hydraulic motor, including following specific steps:
(1) Two identical valve plates 6.1a, 6.1b and two identical cylinder blocks 6.3a, 6.3b are prepared. According to an assembly sequence of the valve plate pair realistic-simulation module 6, the tested valve plate 6.1a and the corresponding cylinder block 6.3a are respectively disposed at corresponding positions of the valve plate pair realistic-simulation module 6, and an initial fit clearance between the valve plate 6.1 and the cylinder block 6.3 is adjusted.
(2) Upon completion of assembly of the valve plate pair realistic-simulation module 6, the transmission shaft 6.8 is connected to the torque sensor 5 through the coupling 4. The valve plate pair realistic-simulation module 6 is fixedly connected to the test bench 13 through the bolt.
(3) The valve plate pair realistic-simulation module chamber oil inlet 15, the valve plate pair high-pressure oil inlet 17, the valve plate pair realistic-simulation module chamber oil return port 19, the valve plate pair loading circuit oil port 20, and the valve plate pair low-pressure oil return port 21 are respectively connected to corresponding oil ports of the hydraulic system. Meanwhile, the valve plate pair leakage port pressure-temperature sensor 10, the valve plate pair high-pressure port pressure-temperature sensor 11, the valve plate pair loading circuit pressure-temperature sensor 12, and the valve plate pair low-pressure port pressure-temperature sensor 23 are respectively disposed at corresponding positions.
(4) The hydraulic system is started. The chamber of the valve plate pair realistic-simulation module is filled with the oil through the valve plate pair realistic-simulation module chamber oil inlet 15. After the chamber of the valve plate pair realistic-simulation module is filled with the oil, the valve plate pair realistic-simulation module chamber oil inlet 15 is closed, the valve plate pair realistic-simulation module chamber oil return port 19 is opened, and a working pressure and an oil temperature of the tested valve plate 6.1 are adjusted.
(5) The motor 1 is started, and a rotational speed of the motor 1 is adjusted to change a working rotational speed for controlling the cylinder block 6.3.
(6) The working pressure and the working rotational speed are adjusted through a test process from Steps (1) to (5), and basic characteristics such as friction characteristics and temperatures of the valve plate in different working conditions can be tested continuously for 15 hours.
(7) Upon completion of testing in the different working conditions, the hydraulic system is switched. The valve plate pair high-pressure oil inlet 17 is closed, such that the tested valve plate is in a non-port distribution working state. The valve plate pair loading circuit oil port 20 is opened. An oil pressure of a loading circuit is adjusted according to a pressing force of the valve plate, such that the oil pressure is consistent with a residual pressing force of the valve plate. A shafting friction torque is tested. The shafting friction torque is subtracted from a friction torque obtained in Step (6) to obtain the friction torque of the valve plate pair.
(8) Upon completion of the above testing, the tested valve plate 6.1a is removed, and a wear state of the valve plate pair is observed through a microscope, as shown in FIG. 8.

Meanwhile, the tested valve plate 6.1b and the corresponding cylinder block 6.3b are disposed in the cam-lobe radial piston hydraulic motor. Working conditions and a test period that are completely the same as those in Steps (4) to (6) are set. Upon completion of the above testing, the tested valve plate 6.1b is removed, and a wear state of the valve plate pair is observed through the microscope, as shown in FIG. 9. By comparison, worn areas of the tested valve plates 6.1a and 6.1b are basically the same, and such wear characteristics as a pear-shaped groove are concentrated at a junction between the high-pressure window and the low-pressure window. This further verifies that the test device and method provided by the present disclosure can realize in-situ testing on the friction characteristic of the interface of the valve plate pair in the cam-lobe radial piston hydraulic motor.

The above described are merely the embodiments of the disclosure and are not intended to constitute a limitation to the scope of the patent of the disclosure. Any equivalent structure or process change made based on the specification and accompanying drawings of the disclosure, or direct or indirect application thereof in other related technical fields, should fall in the protection scope of the patent of the disclosure.

What is claimed is:

1. An in-situ test device for a friction characteristic of an interface of a valve plate pair in a cam-lobe radial piston hydraulic motor, comprising: a motor, a valve plate pair realistic-simulation module, and a valve plate pair guide module, wherein
the valve plate pair realistic-simulation module comprises a transmission shaft, a cylinder block, a loading chamber, a valve plate, as well as a high-pressure port window and a low-pressure port window of the valve plate; the cylinder block in the valve plate pair realistic-simulation module is connected to the motor through the transmission shaft; the high-pressure port window and the low-pressure port window of the valve plate are arranged in a staggered manner; the loading chamber is configured to input oil, such that a loading force of chamber oil is the same as a pressing force of the valve plate to realize calibration of a friction torque in an equivalent in-situ test; a valve plate pair realistic-simulation module chamber oil inlet is configured to input the oil and fill the valve plate pair realistic-simulation module with the oil, so as to simulate an in-situ working environment of a valve plate pair in a hydraulic motor; the valve plate pair guide module comprises an oil inlet circuit and an oil return circuit; the oil inlet circuit of the valve plate pair guide module communicates with the high-pressure port window of the valve plate; the oil return circuit of the valve plate pair guide module communicates with the low-pressure port window of the valve plate; when a cylinder block window of the cylinder block in the valve plate pair realistic-simulation module communicates with the high-pressure port window of the valve plate, high-pressure oil enters an oil port through the oil inlet circuit of the valve plate pair guide module, and then enters an interface of the valve plate pair through the high-pressure port window of the valve plate; the high-pressure oil is input to the cylinder block window of the cylinder block in the valve plate pair realistic-simulation module and enters a piston chamber of the cylinder block, completing a high-pressure oil inflow function of the valve plate; and when the cylinder block window of the cylinder block in the valve plate pair realistic-simulation module communicates with the low-pressure port window of the valve plate, the high-pressure oil in the piston chamber of the cylinder block becomes low-pressure oil, and the low-pressure oil flows from the cylinder block window of the cylinder block in the valve plate pair realistic-simulation module to the low-pressure port window of the valve plate, enters the oil port of the valve plate pair guide module, and returns to an oil tank through the oil return circuit, completing a low-pressure oil outflow function of the valve plate; and
a torque sensor is disposed on the transmission shaft; and the torque sensor is configured to obtain the friction torque of the interface of the valve plate pair through data acquisition, calibration, and calculation.

2. The in-situ test device for the friction characteristic of the interface of the valve plate pair in the cam-lobe radial piston hydraulic motor according to claim 1, wherein the valve plate pair realistic-simulation module is provided with a self-aligning ball bearing configured to ensure that the valve plate pair realistic-simulation module and the valve plate pair guide module are always concentric with the transmission shaft.

3. The in-situ test device for the friction characteristic of the interface of the valve plate pair in the cam-lobe radial piston hydraulic motor according to claim 1, wherein the valve plate pair realistic-simulation module is provided with a thrust cylindrical roller bearing configured to bear an axial force applied to the cylinder block.

4. The in-situ test device for the friction characteristic of the interface of the valve plate pair in the cam-lobe radial piston hydraulic motor according to claim 1, wherein the valve plate pair realistic-simulation module is provided with a port distribution state observation window configured to observe a flow state of a flow field of the valve plate pair.

5. The in-situ test device for the friction characteristic of the interface of the valve plate pair in the cam-lobe radial piston hydraulic motor according to claim 1, wherein the loading chamber of the valve plate pair realistic-simulation module is configured to control an oil input pressure, such that a loading pressure of the loading chamber generates a loading force for the transmission shaft; and the loading force is the same as the pressing force of the valve plate.

6. The in-situ test device for the friction characteristic of the interface of the valve plate pair in the cam-lobe radial piston hydraulic motor according to claim 1, wherein a friction torque between the transmission shaft and a transmission system connected to the transmission shaft is measured by the torque sensor when the valve plate does not work, and a friction torque measured by the torque sensor is calibrated when the valve plate works, thereby eliminating an influence of the friction torque between the transmission shaft and the transmission system connected to the transmission shaft on the friction torque of the valve plate pair, and realizing calibration of the friction torque in the equivalent in-situ test.

7. A test method of the in-situ test device for the friction characteristic of the interface of the valve plate pair in the cam-lobe radial piston hydraulic motor according to claim 1, comprising following steps:
(1) according to an assembly sequence of the valve plate pair realistic-simulation module, respectively disposing a tested valve plate and a corresponding cylinder block at corresponding positions of the valve plate pair realistic-simulation module, and adjusting an initial fit clearance between the tested valve plate and the corresponding cylinder block;
(2) upon completion of assembly of the valve plate pair realistic-simulation module, connecting the transmission shaft to the torque sensor through coupling, and fixedly connecting the valve plate pair realistic-simulation module to a test bench through a bolt;
(3) respectively connecting the valve plate pair realistic-simulation module chamber oil inlet, a valve plate pair high-pressure oil inlet, a valve plate pair realistic-simulation module chamber oil return port, a valve plate pair loading circuit oil port, and a valve plate pair low-pressure oil return port to corresponding oil ports of a hydraulic system, and respectively disposing a valve plate pair leakage port pressure-temperature sensor, a valve plate pair high-pressure port pressure-temperature sensor, a valve plate pair loading circuit pressure-temperature sensor, and a valve plate pair low-pressure port pressure-temperature sensor at corresponding positions;
(4) starting the hydraulic system, filling a chamber of the valve plate pair realistic-simulation module with the oil through the valve plate pair realistic-simulation module chamber oil inlet, closing the valve plate pair realistic-simulation module chamber oil inlet after the chamber of the valve plate pair realistic-simulation module is filled with the oil, opening the valve plate pair realistic-simulation module chamber oil return port, and adjusting a working pressure and an oil temperature of the tested valve plate;
(5) starting the motor, and adjusting a rotational speed of the motor to change a working rotational speed for controlling the cylinder block;
(6) adjusting the working pressure and the working rotational speed through a test process from the steps (1) to (5) to test friction characteristics of the valve plate pair in different working conditions of the tested valve plate;
(7) upon completion of testing in the different working conditions, switching the hydraulic system, closing the valve plate pair high-pressure oil inlet such that the tested valve plate is in a non-port distribution working state, opening the valve plate pair loading circuit oil port, adjusting an oil pressure of a loading circuit according to a pressing force of the tested valve plate such that the oil pressure is consistent with a residual pressing force of the tested valve plate, measuring a friction torque between the transmission shaft and a transmission system connected to the transmission shaft, and subtracting the friction torque from a friction torque measured in the step (6) to obtain a friction torque of the valve plate pair; and
(8) upon completion of the above testing, removing the tested valve plate, and observing a wear state of the valve plate pair through a microscope.

8. The test method according to claim 7, wherein in the in-situ test device, the valve plate pair realistic-simulation module is provided with a self-aligning ball bearing configured to ensure that the valve plate pair realistic-simulation module and the valve plate pair guide module are always concentric with the transmission shaft.

9. The test method according to claim 7, wherein in the in-situ test device, the valve plate pair realistic-simulation module is provided with a thrust cylindrical roller bearing configured to bear an axial force applied to the cylinder block.

10. The test method according to claim 7, wherein in the in-situ test device, the valve plate pair realistic-simulation module is provided with a port distribution state observation window configured to observe a flow state of a flow field of the valve plate pair.

11. The test method according to claim 7, wherein in the in-situ test device, the loading chamber of the valve plate pair realistic-simulation module is configured to control an oil input pressure, such that a loading pressure of the loading chamber generates a loading force for the transmission shaft; and the loading force is the same as the pressing force of the valve plate.

12. The test method according to claim 7, wherein in the in-situ test device, the friction torque between the transmission shaft and the transmission system connected to the transmission shaft is measured by the torque sensor when the valve plate does not work, and a friction torque measured by the torque sensor is calibrated when the valve plate works, thereby eliminating an influence of the friction torque between the transmission shaft and the transmission system connected to the transmission shaft on the friction torque of the valve plate pair, and realizing calibration of the friction torque in the equivalent in-situ test.
